(19) United States
(12) Patent Application Publication
(10) Pub. No.: US 2015/0349954 A1
(43) Pub. Date: Dec. 3, 2015

(54) SYSTEM AND METHOD FOR RANDOM SEED GENERATION

(71) Applicant: Mason Borda, Sunnyvale, CA (US)

(72) Inventor: Mason Borda, Sunnyvale, CA (US)

(21) Appl. No.: 14/730,190

(22) Filed: Jun. 3, 2015

Related U.S. Application Data
(60) Provisional application No. 62/007,349, filed on Jun. 3, 2014.

(51) Int. Cl. H04L 9/08; G06F 21/46

(52) U.S. Cl. CPC H04L 9/0869; H04L 9/0863; G06F 21/46

(57) ABSTRACT

Provided is a method for ensuring security of a system from unauthorized access, comprising the steps of receiving a force and a direction information over time corresponding to a physical movement of a mobile electronic device with a touch screen configured to, be held in a hand, the movement carried out by holding, and moving the mobile device with the hand; creating an analog signal corresponding to the force; digitizing the analog signal to form a set of binary bits; inputting the binary bits into a random number generator; using an output from the random number generator to form a password or a cryptographic key, wherein the password or the cryptographic key is used appropriately by the security system.

### CROSS REFERENCE

The present invention claims the benefit of U.S. provisional Appl. No. 62/007,349, Filed on Jun. 3, 2014, which is incorporated herein by reference in its entirety.

### FIELD OF THE INVENTION

The present invention relates to the field of pseudo-random number generation and computer security.

### BACKGROUND SECTION OF THE INVENTION

Public-key cryptography is often used to secure electronic communication over an open networked environment such as the internet, without relying on a covert channel even for key exchange, Open networked environments are susceptible to a variety of communication security problems such as man-in-the-middle attacks and other security threats. Security properties required for communication typically include that the communication being sent must not be readable during transit

In order to generate a public-key, a random seed needs to be generated. Multiple problems exist with random seed generation. First, the seed that is being generated may not be completely random. Second, a method for seed generation may not be suitable for a mobile device such as a mobile phone. There is a need in the art for producing a random seed for a process carried out by a mobile electronic device.

### SUMMARY SECTION OF THE INVENTION

A random number generator using the onboard MEMS sensor of a smartphone to generate the seed for the generation via an analog-to-digital converter. A prompt given on the smartphone screen during the time of seed generation would ask the user to perform a said task which would require the smartphone to be physically translated in space (i.e. writing their signature with smartphone in hand extended directly ahead). While in motion, the processor will sample the A/D converter at the output of MEMS sensor to receive a n-bit random seed which can be used for random number generation.

Provided is a method for ensuring security of a system from unauthorized access, comprising the steps of: receiving a force and a direction information over time corresponding to a physical movement of a mobile electronic device with a touch screen configured to be held in a hand, the movement carried, out by holding and moving the mobile device with the hand; creating an analog signal corresponding to the force; digitizing the analog signal to form a set of binary bits; inputting the binary bits into a random number generator; using an output from the random number generator to form a password or a cryptographic key, wherein the password or the cryptographic key is used appropriately by the security system. The method can further comprise applying a hash function to the set of binary bits. The hash function can be comprised of a SHA-256 hash. The method can further comprise prompting a user to perform the physical movement. The mobile electronic device can further comprise one or more of accelerometer, gyroscope, magnetometer, and pressure sensor. The method can comprise: a) determining that a new seed is necessary; b) prompting the user to perform the physical movement; c) receiving the force and the direction information over time; d) creating the analog signal by generating a voltage corresponding to the force and the direction information; e) sampling the analog signal; f) digitizing the analog signal; and g) outputting binary n-bits for use as a seed by a random number generator. The method can comprise: a) determining that a new seed is, necessary; b) prompting the user to perform the physical movement; c) receiving the force and the direction information over time; d) creating the analog signal by generating a voltage corresponding to the force and the direction information; e) sampling the analog signal; 0 digitizing the analog signal; and g) outputting binary n-bits for use as a seed by a random number generator; h) salting a preexisting binary data with the seed; and i) performing a hash function with the salted binary data to create a signature. The mobile device can be a mobile phone, tablet computer, or a hand held game console.

Provided is a mobile electronic device with a processor and a touch screen for generating passwords or cryptographic keys used in providing security for confidential information, comprising: a micro-electromechanical system configured to receive a force and a direction information over time corresponding to a physical movement of the mobile electronic device with the touch screen configured to be held in a hand, the movement carried out by holding and moving the mobile device with the hand, and further configured to create an analog signal corresponding to the force; an analog to digital converter configured to digitize the analog signal to form a set of binary bits; a random number generator configured to receive the binary bits and further configured to output a random number to be used to form a password or a cryptographic key, wherein the password or the cryptographic key is used appropriately by the security system. The mobile electronic device can further comprise a module configured to carry out a hash function to the set of binary bits. The hash function can be comprised of a SHA-256 hash. The touch screen on the mobile device can prompt the user to perform a predetermined movement. The mobile phone can further comprise one or more of accelerometer, gyroscope, magnetometer, and pressure sensor in the mobile device. The mobile device can be a mobile phone, tablet computer, or a hand held game console.

Provided is an apparatus for generating passwords or cryptographic keys used in providing security for confidential information, comprising: a) a determining module configured to determine that a new seed is necessary; b) a prompting module configured for prompting the user to perform the physical movement; c) a receiving module configured to receive the force and the direction information over time; d) a creating module configures to create the analog signal by generating a voltage corresponding to the force and the direction information; e) a sampling module configured to sample the analog signal; 0 a digitizing module configures to digitize the analog signal; and g) an outputting module configures to output the binary n-bits for use as a seed by a random number generator.

Provided is a computer-readable memory encoded with data representing a computer program that can cause a computer to generate a pseudo-random number as described above.

### BRIEF DESCRIPTION OF THE FIGURES

FIG. 1 illustrates an exemplary flow chart for creating digital random numbers.

FIG. 2 illustrates an exemplary flow chart for creating a seed to be fed to a random number generator.

FIG. 3 illustrates an exemplary flow chart for creating a seed to be fed to a random number generator.

FIG. 4 illustrates an exemplary flow chart for creating a seed to be fed to a random number generator.

FIG. 5A illustrates a prompt of a pattern to be followed by a user.

FIG. 5B illustrates a user moving a mobile phone according to the figure on screen of the phone.

FIG. 6 illustrates a user and a technology timeline.

FIG. 7 illustrates creation of a signature by slating with a randomly generated, seed.

FIG. 8 illustrates a mobile phone or a tablet computer that prompts a user to take an action.

FIG. 9 illustrates a mobile phone or a tablet computer that is in motion.

### DETAILED DESCRIPTION OF THE INVENTION

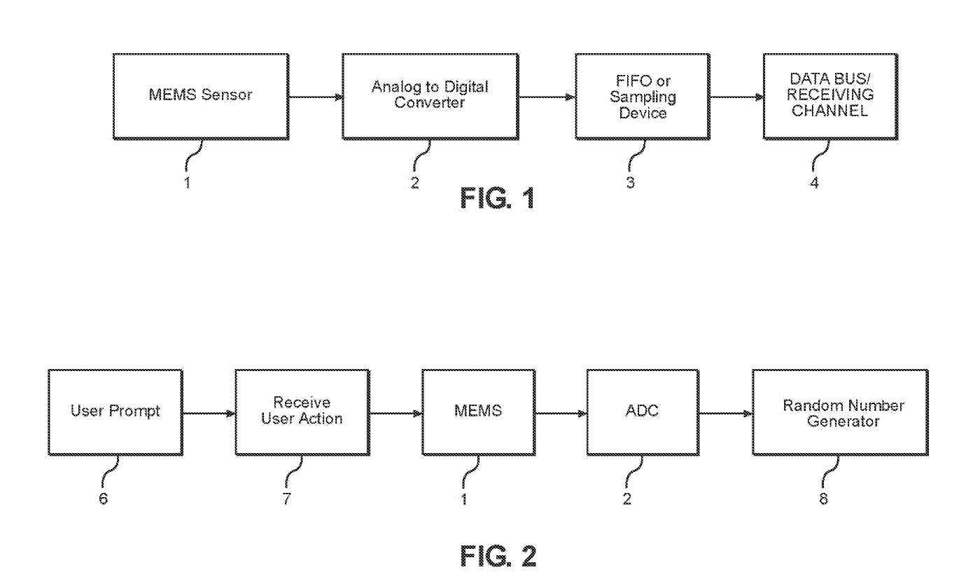

FIG. 1 illustrates an exemplary embodiment where a MEMS sensor 1 converts a physical motion of a device by a user into an analog signal. The physical motion can for example be moving a mobile device back and forth, or making a pattern with the mobile device. The analog signal is then converted to a digital signal with a converter 2. Optionally a sampling device can be used 3 to sample the analog signal at intervals determined by the processor. The digital signal can then be made available at a data bus/receiving channel 4. In another embodiment, the digital signal is directly sent to a random number generator rather than made available at a receiving channel at intervals determined by the processor 4.

FIG. 2 illustrates a flow chart of exemplary steps to create a random seed value, A user is prompted 6 to take an action. For example, the user can be prompted to shake a mobile phone. The mobile device then receives the user action 7, and the user action 7 is converted to an analog signal with the MEMS 1. The analog signal is then converted to a digital signal with a converter 2. The digital signal is then fed as an n-bit random number seed value into a random number generator 8.

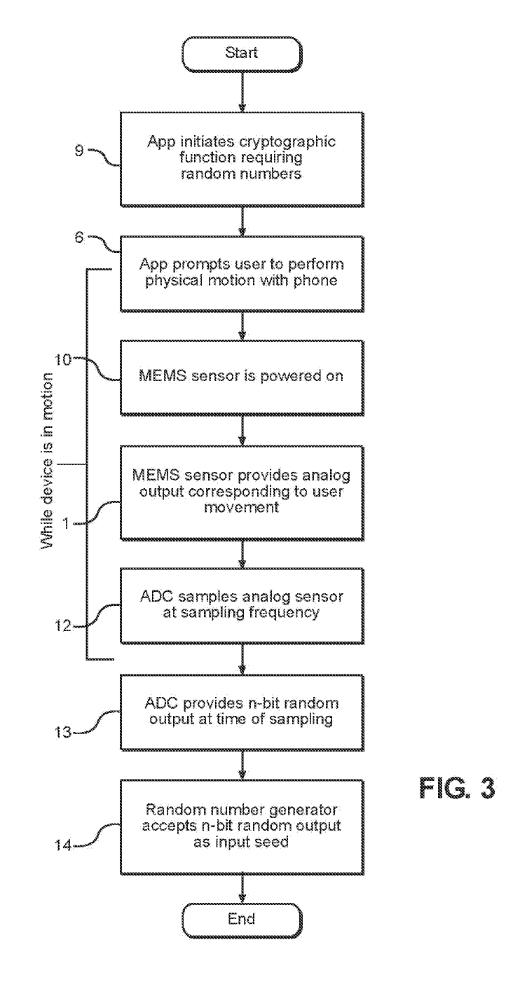

FIG. 3 is a more detailed version of the flowchart of FIG. 2, As illustrated, an application (“App”) 9 initiates a cryptographic function requiring random numbers 9. The App can prompt the user to perform physical motion 6 with the phone or other mobile computing device. When a physical motion is carried out 6, the MEMS sensor can be powered on 10 if not already powered. The MEMS sensor would then provide, an analog output corresponding to the user's movement 1. Optionally the ADC (Analog Digital Converter) samples analog sensor at a predetermined sampling frequency 12. The ADC then provides n-bit random output at the time of sampling 13. The random number generator then accepts n-bit random output as input signal 14. The random number generator can then continually generate random numbers based on a predetermined algorithm based on the seed value at n-intervals.

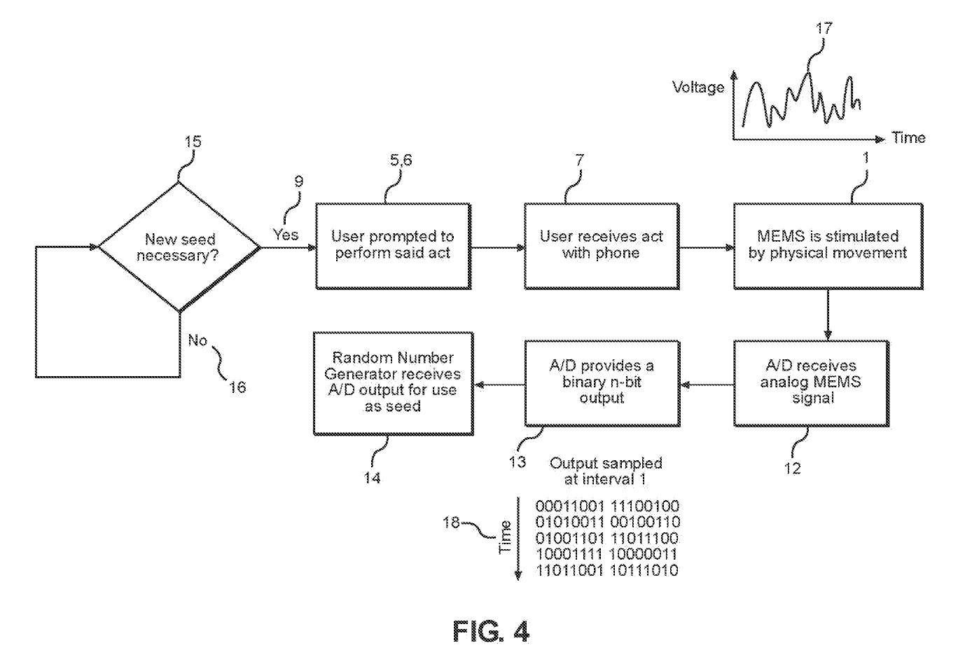

FIG. 4 illustrates a flow chart with additional details for a random seed generation. The hardware, software (APP), or firmware can make a determination if a seed is necessary 15. If no seed is necessary, no additional steps are taken 16. If a seed is necessary 9, the user is prompted to perform an act 6. The MEMS is stimulated by the physical movement 1 so that the MEMS produces a varying analog voltage corresponding to the movement 17. The analog to digital converter then converts the analog signal outputted by the MEMS to a digital signal 12, and outputs a binary n-bit output, as illustrated for example in 18. A random number generator 14 then receives the binary n-bit output for use as a seed 14.

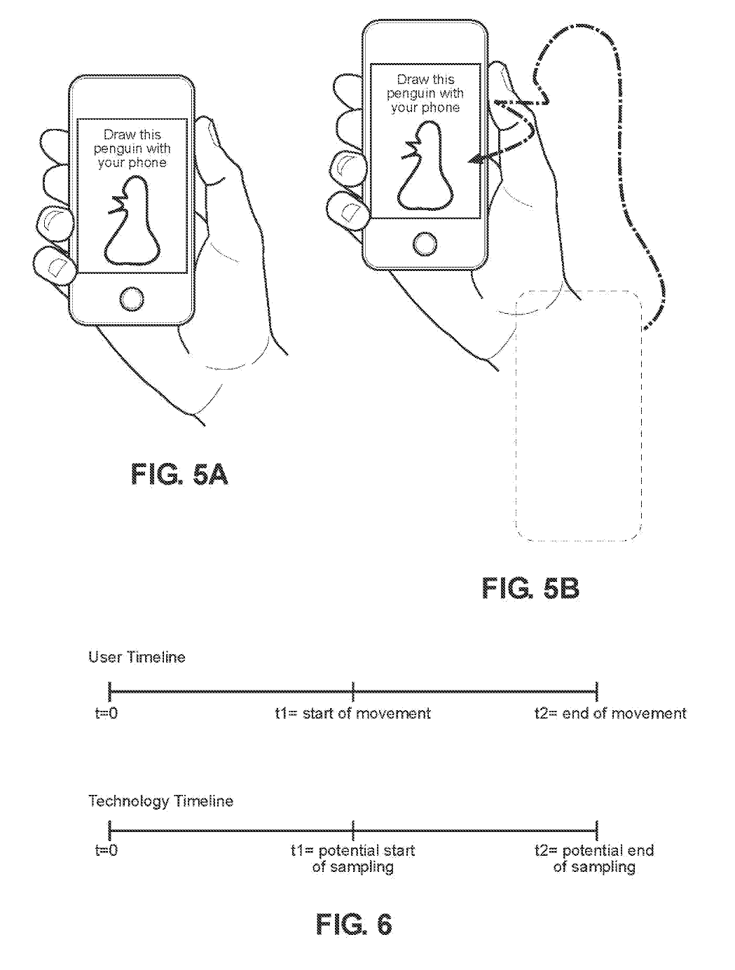

In FIGS. 5A and 5B, the user performs suggested act by moving the smartphone and thereby the onboard MEMS, sensor. FIG. 5A illustrates a user being prompted to move the phone to draw a penguin in the air. FIG. 5B illustrates the drawing of the penguin in the air. The user's natural movement will provide a random stimulus to the analog MEMS sensor.

FIG. 6 illustrates the time at which the user begins movement defines the time t1 at which the random number can be sampled. The MEMS analog output will be provided to the input of the analog to digital converter. The analog-to-digital converter receives the user generated analog signal and provides an n-bit output to be sampled as a random number seed for use in cryptographic applications

A MEMS sensor 1 (Micro-electromechanical systems) can encompass, a wide range of devices including but not limited to accelerometers, gyroscopes, magnetometers, pressure sensors, and even temperature sensors. These devices are motion sensors that convert a physical movement (force and/or direction) to an analog signal. They are frequently found integrated in smartphones which use the gyroscopes and accelerometers to provide speed, acceleration, and direction parameters of the users phone to third parties applications running natively on the device. These third party apps use this information to provide the user with a seemingly limitless set of functionality such as rotating the phones screen to best fit the users perspective to moving a character in a game.

Seeds are the base number which a randomizer can use to provide a random set of numbers for use to provide a unique key. If a given random number generator uses the same seed, every set, of random numbers generated will be the same. If a different seed is provided each time the device can provide a different seed upon each randomization a different set of random numbers will be provided however there are still inherent security risks involved in having a randomizer with a limited number of seeds. An ideal randomizer would have an infinite number of seeds to which the source is unknown to a would be attacker.

The MEMS sensor can provide a varying analog output which can vary based on an external environmental factor of the device in which the MEMS sensor is seated. This analog input will be fed to a DAC (Digital Analog Converter) whose resolution can be varied based on the number of bits or bytes required in the seed. This seed <can be extracted through one of many methods either passively or actively. Passively being that the MEMS sensor is sampled when the user is asked to perform an activity which results in an environmental change to the device which can effectively alter the output of an affected MEMS sensor.

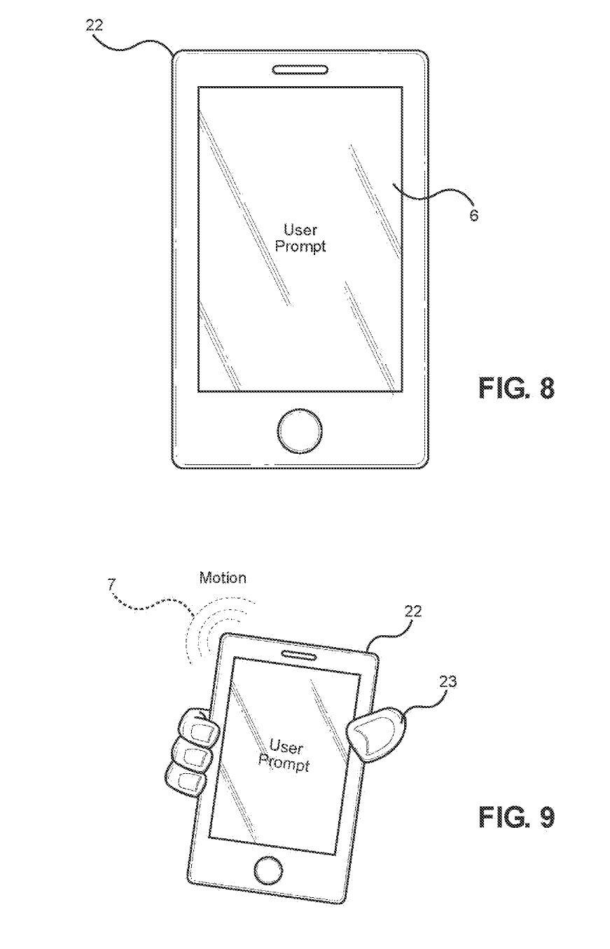

The user can perform different motions with their device. Such as the process of requiring the user to shake their phone or perform a motion which appears on the screen to create a randomized output from the MEMS sensor. One situation would be upon entering their bank information a user is asked to draw a FIG. 8 with their device in the air. Whatever figure the user may be asked to draw can be arbitrary or the same. A person would not be able to make the same motion twice.

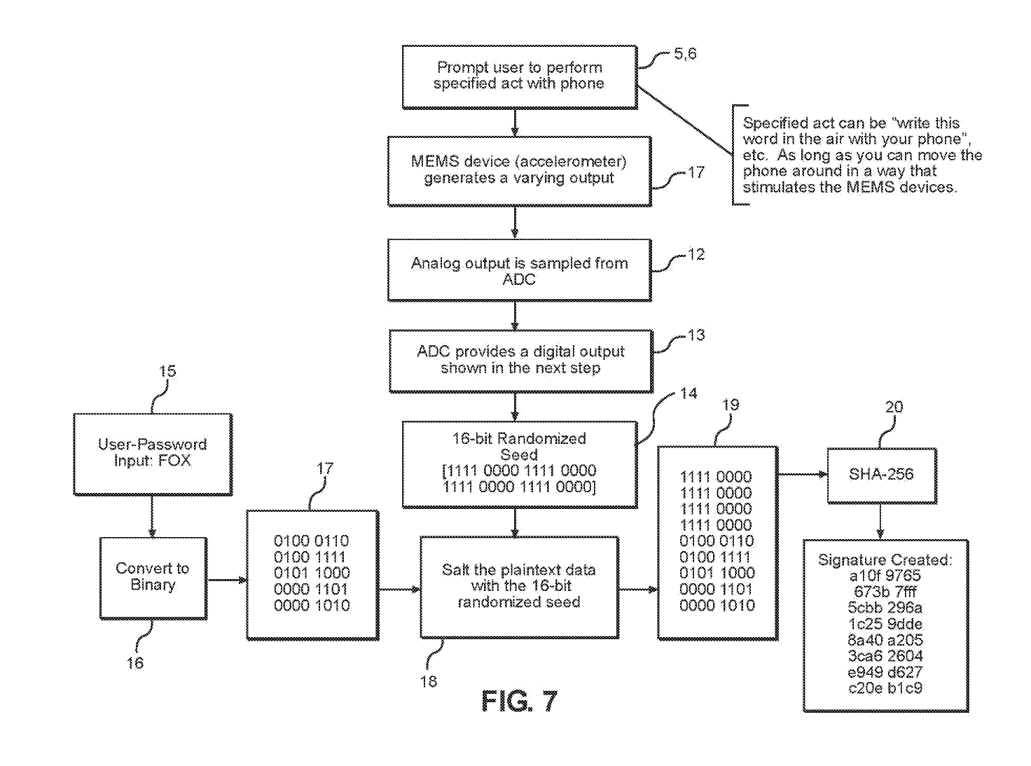

FIG. 7 illustrates a use case for a signature creation similar to the process used in Bitcoin signature generation where a unique pin number or identification is only entered initially to generate a unique “one-way” signature. In this case a SHA-256 hash can be used to provide a sample use case for how MEMS can be used to generate a random seed. Other examples of hash functions include MD5, MD6, RIPEMD, RIPEMD-160, RIPEMD-320, SHA-1, SHA-256, SHA-384, SHA-512. SHA-3, SWIFFT, Senfru, Spectral Hash. In this case, an assumption is made that the MEMS sensor is an accelerometer. In step 15 the user is prompted to input his/her unique password into the system. Step 16 converts the text which in this case is received in ASCII format into binary so that it is in a language that the particular system can understand. Step 17 shows what the result after this conversion has been done. In this example, the users password is “FOX” and after conversion to binary the following is obtained: [0100 0110 0100 1111 0101 1000 0000 1101 0000 1010]. This step is used to stimulate the MEMS sensor 1. Any MEMS sensor 1 has inherent value due to its ability to provide a digital output of an inherently analog behavior. In this case, an accelerometer has been chosen so a user can be prompted to write the answer of a question that, is posed in the air with a phone, or to shake the phone 6. The prompt in step 6 generates a random output 17 from the MEMS 1 sensor since the way in which a person would complete the given task is unique and is only performed in low frequency. This analog is sampled 12 and sent to an Analog to Digital Converter (ADC) 13 so that the output can be used in the digital domain. A random seed has now been generated 14; in this case it will look not so random for demonstration purposes. [1111 0000 1111 0000 1111 0000 1111 0000]. This 4-byte binary output that we have now converted to digital form the analog output of the MEMS sensor is presented in the previous step. We now use this value to “salt” 18 our password which was received in step 1. Salting is concatenating or inserting a random value into a password prior to a one way hashing function to prevent against dictionary attacks. Dictionary attacks are when an attacker tries to determine the password of the user by trying “every possible combination” to figure out the password. Our salted output 19 is now as shown below:
[1111 0000 1111 0000 1111 0000 1111 0000 0100 0110 0100 1111 0101 1000 0000 1101 0000 1010]
   The salted output is now hashed 20 using a one-way hashing function, in our example we chose to use SHA-256. The hashed result is shown below:
a10f9765 673b 7fff 5cbb 296a 1c25 9dde 8a40 a205 3ca6 2604 e949 d627 c20e b1c9

What is created is a signature 21 unique to that user based on the user's password. Real-life applications will can include in the hash a user ID or other unique identifier.

The mobile electronic device is configured to be held in hand and preferably moved by holding in one hand. Examples of such mobile devices include smart watches, smart or mobile phones, and tablet computers. These devices typically have one or more processors, a memory, a storage, a touch screen, a power source such as a battery, one or more chips for connecting to a network, a camera, a speaker, a microphone, a gyroscope, and an accelerometer, The smart phone can have a diagonal screen size of 3 to 6 inches. The tablet computer can have a diagonal screen size of 3 to 6 inches. The Depth of the mobile device can be less than 0.5 inches. The weight of the mobile device can be less than 2 pounds, or less than 1 pound.

MEMS 1 would create an analog signal, convert the analog signal to a digital signal, and then this data packet can be processed by the processor of the mobile device. The random number generator can be embedded in the processor of the mobile device.

What is claimed is:

1. A method for ensuring security of a system from unauthorized access, comprising the steps of:
receiving a force and a direction information over time Corresponding to a physical movement of a mobile electronic device with a touch screen configured to be held in a hand, the movement carried out by holding and moving the mobile device with the hand;
creating, an analog signal corresponding to the force;
digitizing the analog signal to form a set of binary bits;
inputting the binary bits into a random number generator;
using an output from the random number generator to form a password or a cryptographic key, wherein the password or the cryptographic key is used appropriately by the security system.

2. The method of claim 1, further comprising applying a hash function to the set of binary bits.

3. The method of claim 2, wherein the hash function is comprised of a SHA-256 hash.

4. The method of claim 1, further comprising prompting a user to perform the physical movement.

5. The method of claim 1, wherein the mobile electronic device further comprises one or more of accelerometer, gyroscope, magnetometer, and pressure sensor.

6. The method of claim 1, wherein the method comprises:
a) determining that a new seed is necessary;
b) prompting the user to perform the physical movement;
c) receiving the force and the direction information over time;
d) creating the analog, signal by generating a voltage corresponding to the force and the direction information;
e) sampling the analog signal;
f) digitizing the analog signal; and
g) outputting binary n-bits for use as a seed by a random number generator.

7. The method of claim 1, wherein the method comprises:
a) determining that a new seed is necessary;
b) prompting the user to perform the physical movement;
c) receiving the force and the direction information over time
d) creating the analog signal by generating a voltage corresponding to the force and the direction information;
e) sampling the analog signal;
f) digitizing the analog signal; and
g) outputting binary n-bits for use as a seed by a random number generator;
h) salting a preexisting binary data with the seed; and
i) performing a hash function with the salted binary data to create a signature.

8. The method of claim 1, wherein the mobile device is a mobile phone, tablet computer, or a hand held game console.

9. A mobile electronic device with a processor and a touch screen for generating passwords or cryptographic keys used in providing security for confidential information, comprising:
a micro-electromechanical system configured to receive a force and a direction information over time corresponding to a physical movement of the mobile electronic device with the touch screen configured to be held in a hand, the movement carried out by holding and moving the mobile device with the hand, and further configured to create an analog signal corresponding to the force;
an analog to digital converter configured to digitize the analog signal to form a set of binary bits;
a random number generator configured to receive the binary bits and further configured to output a random number to be used to form a password or a cryptographic key, wherein the password or the cryptographic key is used appropriately by the security system.

10. The mobile electronic device of claim 9, further comprising a module configured to carry out a hash function to the set of binary bits.

11. The mobile electronic device of claim 10, wherein the hash function is comprised of a SHA-256 hash.

12. The mobile electronic device of claim 9, further comprising a touch screen on the mobile device to prompt the user to perform a predetermined movement.

13. The mobile electronic device of claim 9, further comprising one or more of accelerometer, gyroscope, magnetometer, and pressure sensor in the mobile device.

14. The mobile electronic device of claim 9, wherein the mobile device is a mobile phone tablet computer, or a hand held game console.

15. An apparatus for generating passwords or cryptographic keys used in providing security for confidential information, comprising:
a) a determining module configured to determine that a new seed is necessary;
b) a prompting module configured for prompting the user to perform the physical movement;
c) a receiving module configured to receive the force and the direction information over time;
d) a creating module configures to create the analog signal by generating a voltage corresponding to the force and the direction information;
e) a sampling module configured to sample the analog signal;
f) a digitizing module configures to digitize the analog signal; and
g) an outputting module configures to output the binary n-bits for use as a seed by a random number generator.
